(19) United States
(12) Patent Application Publication
(10) Pub. No.: US 2022/0409472 A1
(43) Pub. Date: Dec. 29, 2022

(54) MASSAGE NECK PILLOW

(71) Applicant: Shanghai Sintang Industrial Co.,Ltd., Shanghai (CN)

(72) Inventors: Chuankui Du, Shanghai (CN); Saihua Chen, Shanghai (CN); Jinnian Dong, Shanghai (CN)

(73) Assignee: Shanghai Sintang Industrial Co.,Ltd., Shanghai (CN)

(21) Appl. No.: 17/900,891

(22) Filed: Sep. 1, 2022

(30) Foreign Application Priority Data
Jul. 10, 2022 (CN) 202221722271.4

(51) Int. Cl. A61H 7/00

(52) U.S. Cl. CPC A61H 7/007; A61H 2201/1609; A61H 2205/04; A61H 2201/165; A61H 2201/0192; A61H 2201/1238; A61H 2201/1695; A61H 2007/009; A61H 2201/0134

(57) ABSTRACT

The present disclosure is applicable to the technical field of massage apparatuses, and provides a massage neck pillow. The massage neck pillow includes neck pillow sponge, a massage unit and an air bag. The neck pillow sponge adopts an elastic material capable of achieving bending deformation; the neck pillow sponge bends to form a wearing area for clamping the neck of a user; and a reserved sunken part is arranged in an area of the neck pillow sponge close to the nape part of the user.

### TECHNICAL FIELD

The present disclosure belongs to the technical field of massage apparatuses, and particularly relates to a massage neck pillow.

### BACKGROUND

A massage unit of an existing electric massage neck pillow is often higher. When a massage function is not required, if the electric massage neck pillow is used as an ordinary sponge travel pillow, the protruding massage unit will push against the neck of a user, leading to discomfort.

### SUMMARY

An embodiment of the present disclosure aims to provide a massage neck pillow, and aims at solving the problem of discomfort caused by pressure on the neck since a massage unit protrudes when an existing massage neck pillow is not used for massaging.

The embodiment of the present disclosure is achieved below: A massage neck pillow includes neck pillow sponge, a massage unit and an air bag. The neck pillow sponge adopts an elastic material capable of achieving bending deformation; the neck pillow sponge bends to form a wearing area for clamping the neck of a user; a reserved sunken part is arranged in an area of the neck pillow sponge close to the nape part of the user; both the air bag and the massage unit are arranged in the reserved sunken part; the massage unit is arranged at a position, close to the neck of the user, on an outer side of the air bag; and the air bag is arranged in an interlayer between the massage unit and the reserved sunken part on the neck pillow sponge.

In a further technical solution, the air bag is inflated and deflated in a recyclable manner; and the thickness of the air bag changes by means of inflation and deflation.

In a further technical solution, two ends of the air bag are respectively connected to the neck pillow sponge and the massage unit.

In a further technical solution, the air bag is inflated to push the massage unit to be close to the nape part of the user.

In a further technical solution, the air bag is deflated to pull the massage unit to be away from the nape part of the user.

In a further technical solution, an air inlet and outlet hose is provided on the air bag.

In a further technical solution, a boundary dimension of the air bag when the air bag is not inflated is smaller than the reserved sunken part.

In a further technical solution, a boundary dimension of the air bag is matched with a dimension of the massage unit.

According to the massage neck pillow provided by the embodiment of the present disclosure, a user wears the neck pillow sponge on the neck. When the user needs massage, the massage unit is turned on to massage the neck; if higher massage strength is required, the user inflates the air bag to increase a thickness of the air bag, so as to increase a pressure applied by the massage unit to the neck, thus increasing the massage strength; if lower massage strength is required, the user deflates the air bag to decrease the thickness of the air bag, so as to reduce the pressure applied by the massage unit to the neck, thus decreasing the massage strength; after the user turns off the massage unit, the air bag can be completely deflated to decrease the thickness of the air bag to the minimum, so that the massage unit is thoroughly made to be away from the neck of the user.

### BRIEF DESCRIPTION OF THE DRAWINGS

FIG. 1 is a schematic diagram of wearing of a massage neck pillow provided in an embodiment of the present disclosure;

FIG. 2 is a top view of a massage neck pillow provided in an embodiment of the present disclosure;

FIG. 3 is an exploded diagram of a massage neck pillow provided in an embodiment of the present disclosure;

FIG. 4 is a schematic diagram of an air bag of a massage neck pillow provided in an embodiment of the present disclosure.

In the drawings: neck pillow sponge 1, massage unit 2, air bag 3, air inlet and outlet hose 4, air bag support plate 5, control box 6, control button 7, control circuit board 8, internal wire 9, rechargeable battery 10, clamping locking device 11, neck pillow cloth cover 13, air pump 14, and air valve 15.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

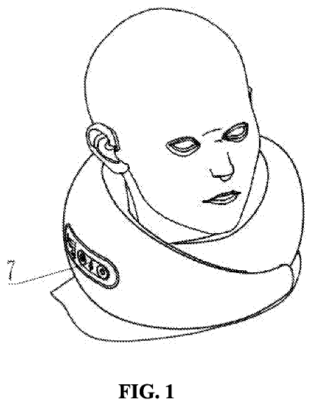

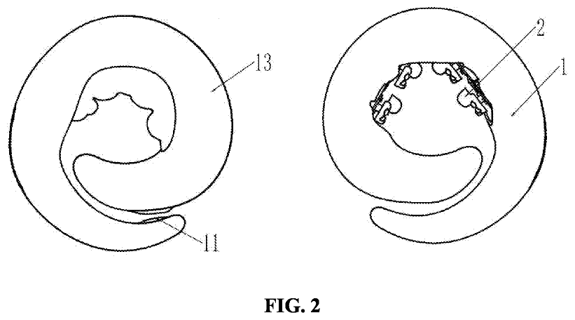

As shown in FIG. 1 to FIG. 3, a massage neck pillow provided by one embodiment of the present disclosure includes neck pillow sponge 1, a massage unit 2 and an air bag 3. The neck pillow sponge 1 adopts an elastic material capable of achieving bending deformation; the neck pillow sponge 1 bends to form a wearing area for clamping the neck of a user; a reserved sunken part is arranged in an area of the neck pillow sponge 1 close to the nape part of the user; both the air bag 3 and the massage unit 2 are arranged in the reserved sunken part; the massage unit 2 is arranged at a position, close to the neck of the user, on an outer side of the air bag 3; and the air bag 3 is arranged in an interlayer between the massage unit 2 and the reserved sunken part on the neck pillow sponge 1.

In the embodiment of the present disclosure, a user wears the neck pillow sponge 1 on the neck. When the user needs massage, the massage unit 2 is turned on to massage the neck; if higher massage strength is required, the user inflates the air bag 3 to increase a thickness of the air bag 3, so as to increase a pressure applied by the massage unit 2 to the neck, thus increasing the massage strength; if lower massage strength is required, the user deflates the air bag 3 to decrease the thickness of the air bag 3, so as to reduce the pressure applied by the massage unit 2 to the neck, thus decreasing the massage strength; after the user turns off the massage unit, the air bag 3 can be completely deflated to decrease the thickness of the air bag 3 to the minimum, so that the massage unit is thoroughly made to be away from the neck of the user.

As shown in FIG. 1 to FIG. 3, as one preferable embodiment of the present disclosure, the massage neck pillow further includes clamping locking devices 11 and a neck pillow cloth cover 13. An outer surface of the neck pillow sponge 1 is wrapped with the neck pillow cloth cover 13. Two ends of the neck pillow cloth cover 13 are provided with the clamping locking devices 11. The neck pillow sponge 1 is tied to the neck of the user through the locking of the clamping locking devices 11. The clamping locking devices 11 may adopt connecting devices such as hook and loop fasteners.

As shown in FIG. 1 to FIG. 3, as one preferable embodiment of the present disclosure, an air bag support plate 5 is mounted in a reserved sunken part that is arranged in an area of the soft sponge 12 close to the nape part of the user. One air bag 3 is mounted at each of two ends of the same side of the air bag support plate 5. The outline of the air bag 3 is consistent with that of the massage unit 2. One end of the air bag 3 is fixedly connected to the air bag support plate 5, and the other end of the air bag 3 is fixedly connected to the massage unit 2.

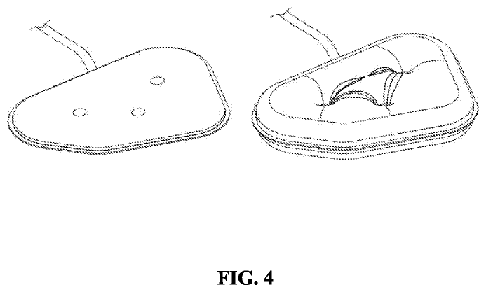

As shown in FIG. 4, as one preferable embodiment of the present disclosure, the air bag 3 is formed by combining two pieces of flexible thermoplastic polyurethane (TPU) materials. When the two pieces of flexible TPU materials are combined, peripheries of the materials are welded by high-frequency waves, and a plurality of welding points are provided in middle areas. In such a combining method, when the air bag 3 is inflated, an inflation thickness of the air bag can decrease, so that the maximum increased thickness is less than 3 cm when the air bag 3 is inflated, and the thicknesses of all parts on the surface during expansion of the air bag 3 increase uniformly; and the phenomena of excessive bulging of the center and excessive shrinkage of the periphery of the air bag 3 are avoided.

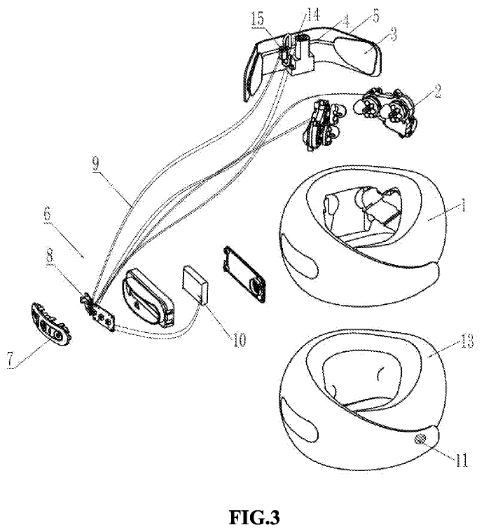

As shown in FIG. 3 and FIG. 4, as one preferable embodiment of the present disclosure, the air bag 3 and the massage unit 2 have the same shapes. The massage unit 2 can be supported in both cases that the air bag 3 is inflated to increase the thickness and is deflated to decrease the thickness.

As shown in FIG. 3 and FIG. 4, as one preferable embodiment of the present disclosure, an inflation and deflation opening is formed in the air bag 3; an air inlet and outlet hose 4 is mounted at the inflation and deflation opening; and the air inlet and outlet hose 4 is used for inflating and deflating the air bag 3.

As shown in FIG. 3, as one preferable embodiment of the present disclosure, an air pump 14 and an air valve 15 are mounted in a center area of the air bag support plate 5, and are respectively connected to the air inlet and outlet hose 4; the air pump 14 can inflate the air bag 3 through the air inlet and outlet hose 4; and the air valve 15 is used for controlling air supply and air discharge.

As shown in FIG. 3 and FIG. 4, as one preferable embodiment of the present disclosure, the two massage units 2 are rotary kneading movements; each massage unit 2 is provided with two rotary massage heads; each rotary head is provided with a plurality of protruding points; and the massage units 2 massage the nape part of the user through the rotation of the rotary massage heads.

As shown in FIG. 3, as one preferable embodiment of the present disclosure, a sunken part is arranged at a position, away from the neck area, on the soft-filled sponge 12; a control box 6 is placed at the sunken part; a rechargeable battery 10, a control circuit board 8 and a control button 7 are arranged inside the control box 6; and the rechargeable battery 10 can be repeatedly charged for multiple times.

As shown in FIG. 3 and FIG. 4, as one preferable embodiment of the present disclosure, the control button 7 is connected to the control circuit board 8. The control circuit board 8 is connected to the rechargeable battery 10 and is connected to the massage unit 2, the air pump 14 and the air valve 15 respectively through internal wires 9. The air pump 14 and the air valve 15 are connected to the air bag 3 through the air inlet and outlet hose 4. The user can control the massage unit 2 to be turned on and turned off by means of operating the control button 7. The user can control the air pump 14 to supply air to the air bag 3 and to cut off the air supply by means of operating the control button 7. The user can control the air valve 15 to deflate the air bag 3 by means of controlling the control button 7. The air bag 3 is inflated by air supplied by the air pump 14 and is deflated by the air valve 15.

The above embodiment of the present disclosure provides a massage neck pillow. A user wears the neck pillow sponge 1 on the neck. When the user needs massage, the massage unit 2 is turned on through the control button 7 to massage the neck. If higher massage strength is required, the control circuit board 8 can be controlled through the control button 7 to trigger the air pump 14 to inflate the air bag 3, so the thickness of the air bag 3 increases, and a pressure applied by the massage unit 2 to the neck increases, thus increasing the massage strength. If lower massage strength is required, the air valve 15 is controlled through the control button 7 to deflate the air bag 3, so the thickness of the air bag 3 decreases, and the pressure applied by the massage unit 2 to the neck decreases, thus decreasing the massage strength. After the user turns off the massage unit, the air valve 15 can be controlled through the control button 7 to completely deflate the air bag 3 to decrease the thickness of the air bag 3 to the minimum, so that the massage unit is thoroughly made to be away from the neck of the user.

The above descriptions are only the preferred embodiments of the present utility model, and are not intended to limit the present utility model. Any modifications, equivalent replacements and improvements that are made within the spirit and principle of the present utility model shall fall within the protection scope of the present utility model.

What is claimed is:

1. A massage neck pillow, comprising neck pillow sponge, a massage unit and an air bag, wherein the neck pillow sponge adopts an elastic material capable of achieving bending deformation; the neck pillow sponge bends to form a wearing area for clamping the neck of a user; a reserved sunken part is arranged in an area of the neck pillow sponge close to the nape part of the user; both the air bag and the massage unit are arranged in the reserved sunken part; the massage unit is arranged at a position, close to the neck of the user, on an outer side of the air bag; and the air bag is arranged in an interlayer between the massage unit and the reserved sunken part on the neck pillow sponge.

2. The massage neck pillow according to claim 1, wherein the air bag is inflated and deflated in a recyclable manner; and the thickness of the air bag changes by means of inflation and deflation.

3. The massage neck pillow according to claim 2, wherein two ends of the air bag are respectively connected to the neck pillow sponge and the massage unit.

4. The massage neck pillow according to claim 3, wherein the air bag is inflated to push the massage unit to be close to the nape part of the user.

5. The massage neck pillow according to claim 3, wherein the air bag is deflated to pull the massage unit to be away from the nape part of the user.

6. The massage neck pillow according to claim 5, wherein an air inlet and outlet hose is provided on the air bag.

7. The massage neck pillow according to claim 5, wherein a boundary dimension of the air bag when the air bag is not inflated is smaller than the reserved sunken part.

8. The massage neck pillow according to claim 5, wherein a boundary dimension of the air bag is matched with a dimension of the massage unit.
